(19) United States
(12) Patent Application Publication
(10) Pub. No.: US 2007/0299373 A1
(43) Pub. Date: Dec. 27, 2007

(54) Body vibrating mechanism

(75) Inventor: Ming Nan Chen, Taichung Hsien (TW)

Correspondence Address: CHARLES E. BAXLEY, ESQ., 90 JOHN STREET, THIRD FLOOR, NEW YORK, NY, 10038, US

(73) Assignee: Michael LIN

(21) Appl. No.: 11/476,871

(22) Filed: Jun. 27, 2006

(51) Int. Cl. A61H 1/02

(52) U.S. Cl. 601/30; 601/23

(57) ABSTRACT

A body vibrating device includes a foot support pivotally supported on a base with a pivot rod, a reduction gearing device disposed on the base and having an eccentric member coupled to the foot support and spaced from the pivot rod for allowing the foot support to be pivoted relative to the base with the pivot rod and to be rotated and driven by the reduction gearing device, and a motor is coupled to the reduction gearing device for driving the reduction gearing device to rotate and to vibrate the foot support. The foot support may be stably supported on the base with the pivot rod, and may be effectively rotated and vibrated by the motor and the reduction gearing device.

### BACKGROUND OF THE INVENTION

1. Field of the Invention

The present invention relates to a body vibrating mechanism, and more particularly to a body vibrating mechanism including a stable structure for stably supporting a user thereon and for suitably vibrating and massaging the whole user' body and for facilitating the blood and/or lymph circulation of the user and for decomposing or for burning the fatty tissue and thus for suitably reducing the fat from the user.

2. Description of the Prior Art

Various kinds of typical body vibrating mechanisms have been developed and comprise a platform for supporting the user thereon, and a hollow vibrating mechanism coil and a pair of armatures provided for vibrating the platform in order to suitably vibrate and massage the user who is standing on the platform.

For example, U.S. Pat. No. 2,271,382 to Worthington discloses one of the typical platform foot and body vibrating mechanism also comprising one of two armatures attached or secured to a platform and a hollow vibrating mechanism coil for acting with the armatures and thus for generating magnetic fields or magnetic forces in order to vibrate or to swing the platform and thus to suitably vibrate and massage the user who is standing on the platform.

For moving or vibrating the platform, a great magnetic field and thus a great magnetic force are required to be generated by the hollow vibrating mechanism coil and the armatures. However, the magnetic field and the magnetic force generated by the hollow vibrating mechanism coil and the armatures are not good for the users and may have a good chance to hurt the users, particularly the nerve systems of the users.

U.S. Pat. No. 2,935,064 to Moxley discloses another typical foot massage apparatus comprising a motor including a spindle or armature shaft coupled to an eccentric member which is indirectly coupled to a platform with such as a cylindrical member or a frame work, such that the platform may only be operated or vibrated or moved with a relatively smaller moving or vibrating stroke by the eccentric member.

U.S. Pat. No. 6,083,180 to Shimizu discloses a further typical vibrating mechanism-type massaging device also comprising a motor coupled to two rotors each including an eccentric shaft extended upwardly therefrom for being moved or driven to move in circular and planar and horizontal plans such that the user may not be vibrated or moved up and down and such that the massaging effect is limited.

An additional motor may further be provided and coupled to a threaded shaft with a rotary gear for moving a vibrating plate up and down relative to a supporting casing. However, the moving speed of the vibrating plate by the threaded shaft and the motorized rotary gear is limited and may not be used to vibrate the vibrating plate and the users.

The present invention has arisen to mitigate and/or obviate the afore-described disadvantages of the conventional body vibrating mechanisms.

### SUMMARY OF THE INVENTION

The primary objective of the present invention is to provide a body vibrating mechanism including a stable structure for stably supporting a user thereon and for suitably vibrating and massaging the whole user' body and for facilitating the blood and/or lymph circulation of the user and for decomposing or for burning the fatty tissue and thus for suitably reducing the fat from the user.

In accordance with one aspect of the invention, there is provided a body vibrating mechanism comprising a base, a foot support pivotally supported on the base with a pivot rod, a reduction gearing device disposed on the base and including an eccentric member coupled to the foot support and spaced from the pivot rod for allowing the foot support to be pivoted relative to the base with the pivot rod and to be rotated and driven by the reduction gearing device, and a motor coupled to the reduction gearing device for driving the reduction gearing device to rotate and to vibrate the foot support.

The motor includes a spindle, the reduction gearing device includes a pulley attached thereto and coupled to the spindle of the motor with a belt for allowing the reduction gearing device to be rotated and driven by the motor.

The foot support includes a bracket attached thereto, and the eccentric member of the reduction gearing device is pivotally coupled to the bracket of the foot support with a lever for allowing the foot support to be rotated and driven by the reduction gearing device.

The lever is pivotally coupled to the bracket of the foot support with one or more bearings for allowing the lever to be smoothly coupled to the foot support. The base includes two plates disposed thereon and spaced away from each other for pivotally supporting the pivot rod. The base includes a post extended upwardly therefrom for supporting a control device thereon.

The base include at least one handle device disposed thereon for supporting an upper portion of a user. The base includes a housing engaged thereon for covering and shielding the pivot rod, the motor and the reduction gearing device and for preventing the user from being clamped or hurt by the housing and the foot support.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial perspective view of a body vibrating mechanism in accordance with the present invention as seen from the rear portion of the body vibrating mechanism;

FIG. 2 is an enlarged partial perspective view illustrating a vibrating device of the body vibrating mechanism as also seen from the rear portion of the body vibrating mechanism;

FIG. 3 is a rear plan schematic view illustrating the vibrating device of the body vibrating mechanism;

FIG. 4 is a front plan schematic view illustrating the vibrating device of the body vibrating mechanism; and

FIG. 5 is a front plan schematic view similar to FIG. 4, illustrating the operation of the body vibrating mechanism.

### DETAILED DESCRIPTION OF THE PREFERRED EMBODIMENT

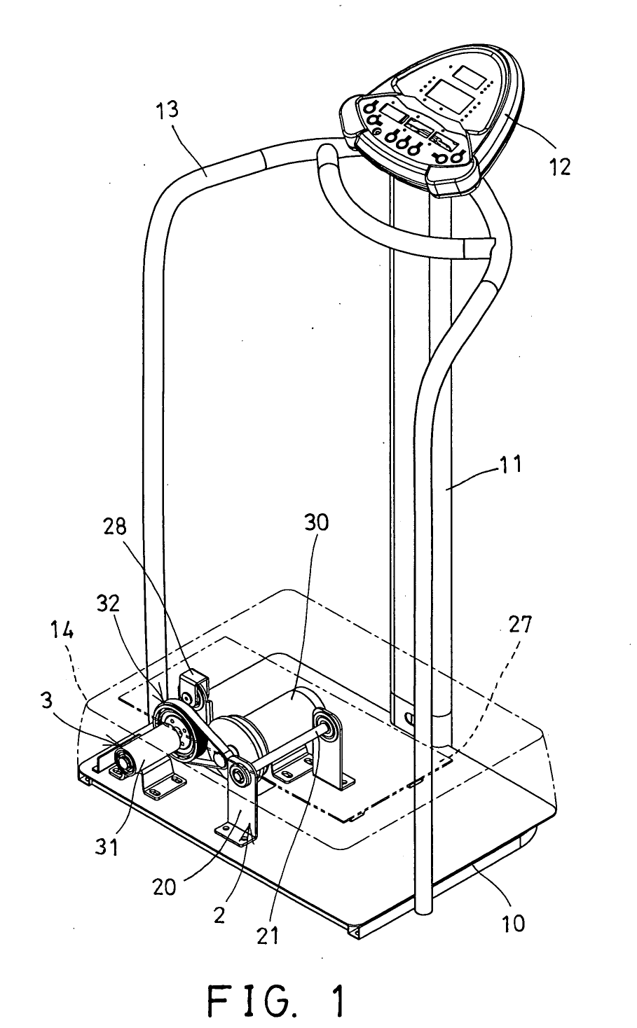

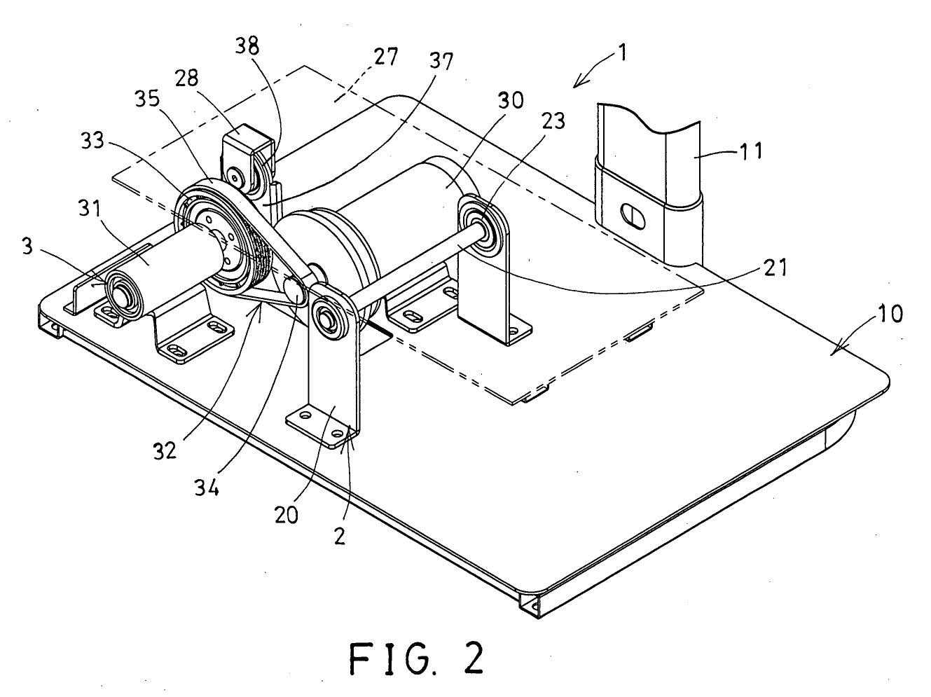

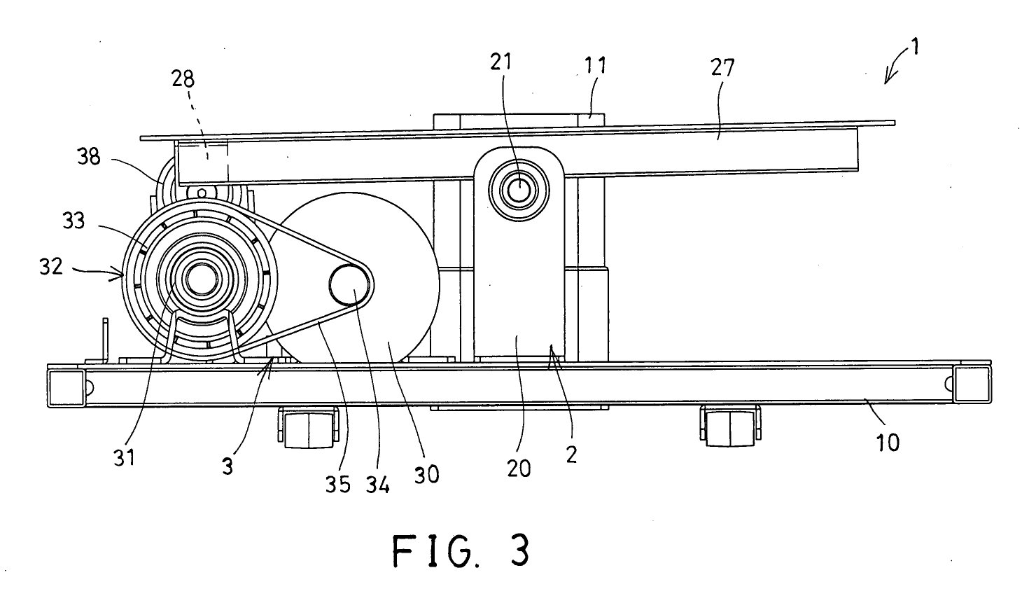

Referring to the drawings, and initially to FIGS. 1-4, a body vibrating mechanism 1 in accordance with the present invention comprises a base 10 for supporting a support device 2 and a vibrating device 3 thereon, and including a post 11 extended upwardly therefrom, such as extended upwardly from the front portion thereof for supporting a displayer or control device 12 thereon, and including one or more handle devices 13 disposed thereon and/or attached or coupled to the post 11 for supporting the upper portions of the users, and including a cover or housing 14 engaged or attached onto the base 10 for covering or shielding or protecting the support device 2 and the vibrating device 3 and for preventing the support device 2 and the vibrating device 3 from being exposed.

The support device 2 includes one or more, such as two plates 20 disposed on the base 10 and spaced away from each other and preferably parallel to each other, a rod 21 rotatably attached or disposed to the plates 20 with bearings 23 and disposed or straddled between the plates 20, and a foot pedal or support 27 attached or secured to the rod 21 and rotated in concert with the rod 21, for allowing the foot support 27 to be rotated or pivoted or swung or vibrated relative to the rod 21, and/or for allowing the foot support 27 to be rotatably supported on the rod 21 and for supporting a user on the foot support 27. An inverted U-shaped bracket 28 may be attached or secured to the bottom of the foot support 27 with such as fasteners or latches (not shown) and spaced from the rod 21 for a suitable distance.

The vibrating device 3 includes a motor 30 and a reduction gearing device 31 disposed on the base 10 and coupled together with a coupling means or device 32 which includes a pulley 33 attached or secured to the reduction gearing device 31 and coupled to the spindle 34 of the motor 30 with a belt 35 for allowing the reduction gearing device 31 to be rotated or driven by the motor 30. However, the coupling device 32 may also be selected from the other coupling devices 32, such as the gearing coupling device 32, the sprocket-and-chain coupling device 32, the motorized threaded coupling device 32, or the like.

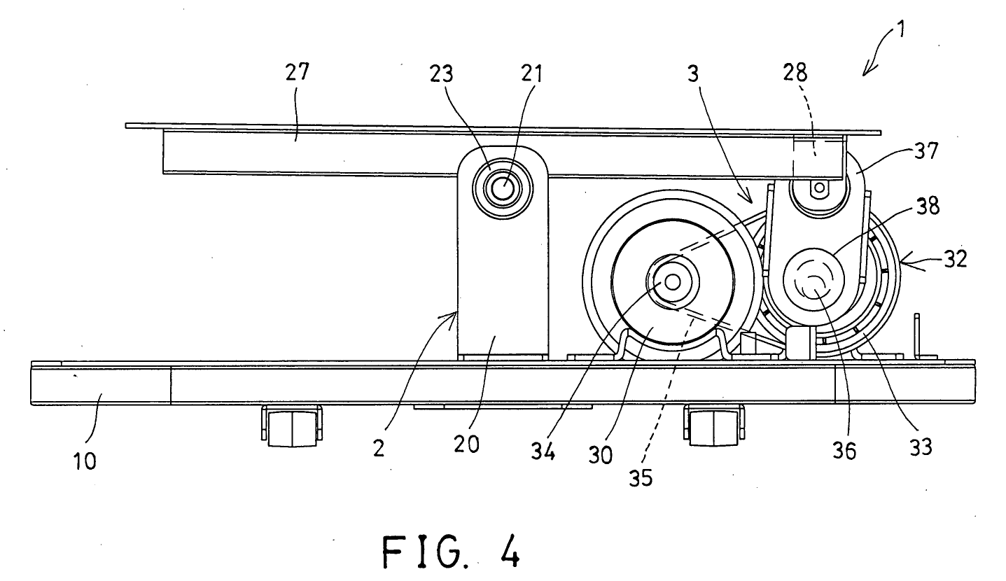

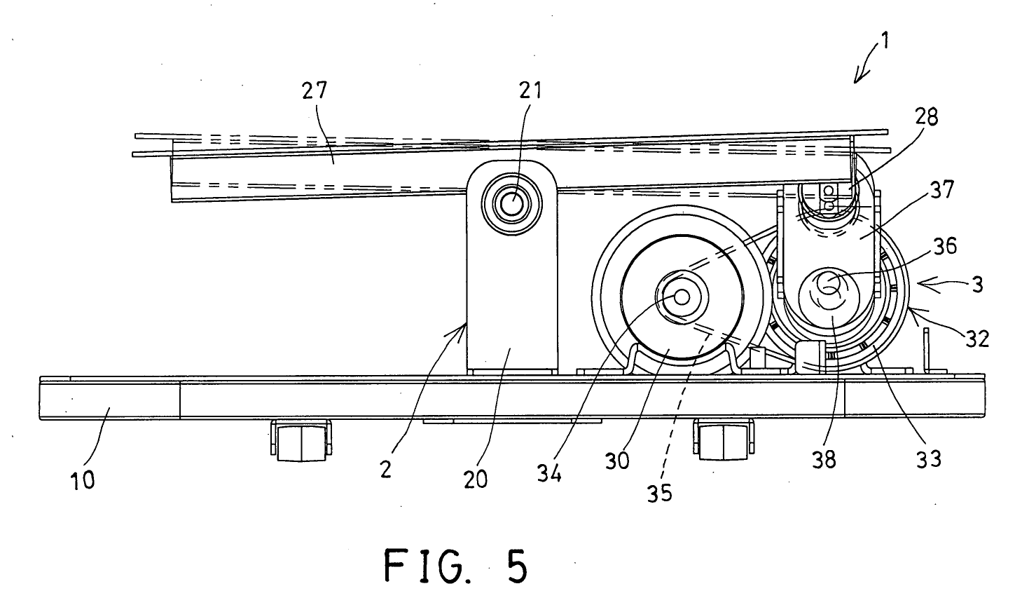

The reduction gearing device 31 includes a crank or eccentric member 36 attached thereto or extended therefrom (FIGS. 4, 5), such as extended from either the spindle 34 or the pulley 33 and coupled to the foot support 27 with a lever 37 and one or more bearings 38 for allowing the foot support 27 to be rotated or driven by the motor 30 via or with the reduction gearing device 31 and the eccentric member 36 and the lever 37, such that the foot support 27 and thus the user supported on the foot support 27 may be swung or vibrated by the motor 30.

For example, the lever 37 may be rotatably or pivotally coupled the bracket 28 of the foot support 27 with one or more of the bearings 38 for allowing the foot support 27 to be rotated or vibrated relative to the rod 21 by the eccentric member 36 and the lever 37. It is preferable that the foot support 27 is coupled to the housing 14 with a bellows type coupling member (not shown) for preventing a gap or slot from being formed between the foot support 27 and the housing 14 and for preventing the user from being clamped or hurt by or between the foot support 27 and the housing 14.

It is to be noted that the foot support 27 may be solidly and pivotally supported on the base 10 with the pivot rod 21, and may be solidly and pivotally coupled the motor 30 via or with the lever 37, the eccentric member 36, and the reduction gearing device 31, and may thus be effectively swung or vibrated by the motor 30, in order to effectively swing or vibrate the whole user' body and to facilitate the blood and/or lymph circulation of the user and to decompose or to burn the fatty tissue of the user and thus for suitably reducing the fat from the user. The lever 37, the eccentric member 36, and the reduction gearing device 31 may thus be formed or acted as a coupling means or mechanism or device for pivotally coupling the motor 30 to the foot support 27.

Accordingly, the body vibrating mechanism in accordance with the present invention includes a stable structure for stably supporting a user thereon and for suitably vibrating and massaging the whole user' body and for facilitating the blood and/or lymph circulation of the user and for decomposing or for burning the fatty tissue and thus for suitably reducing the fat from the user.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A body vibrating mechanism comprising:
a base,
a foot support pivotally supported on said base with a pivot rod,
a reduction gearing device disposed on said base and including an eccentric member coupled to said foot support and spaced from said pivot rod for allowing said foot support to be pivoted relative to said base with said pivot rod and to be rotated and driven by said reduction gearing device, and
a motor coupled to said reduction gearing device for driving said reduction gearing device to rotate and to vibrate said foot support.

2. The body vibrating mechanism as claimed in claim 1, wherein said motor includes a spindle, said reduction gearing device includes a pulley attached thereto and coupled to said spindle of said motor with a belt for allowing said reduction gearing device to be rotated and driven by said motor.

3. The body vibrating mechanism as claimed in claim 1, wherein said foot support includes a bracket attached thereto, and said eccentric member of said reduction gearing device is pivotally coupled to said bracket of said foot support with a lever for allowing said foot support to be rotated and driven by said reduction gearing device.

4. The body vibrating mechanism as claimed in claim 1, wherein said lever is pivotally coupled to said bracket of said foot support with a bearing.

5. The body vibrating mechanism as claimed in claim 1, wherein said base includes two plates disposed thereon and spaced away from each other for pivotally supporting said pivot rod.

6. The body vibrating mechanism as claimed in claim 1, wherein said base includes a post extended upwardly therefrom for supporting a control device thereon.

7. The body vibrating mechanism as claimed in claim 1, wherein said base includes at least one handle device disposed thereon for supporting an upper portion of a user.

8. The body vibrating mechanism as claimed in claim 1, wherein said base include a housing engaged thereon for covering and shielding said pivot rod, said motor and said reduction gearing device.
